(19) United States
(12) Patent Application Publication
(10) Pub. No.: US 2007/0239871 A1
(43) Pub. Date: Oct. 11, 2007

(54) System and method for transitioning to new data services

(76) Inventor: Mike Kaskie, Golf, IL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/402,098

(22) Filed: Apr. 11, 2006

(51) Int. Cl. G06Q 10/00; G06F 15/173; G06Q 30/00

(52) U.S. Cl. 709/224; 705/1

(57) ABSTRACT

A system and method for providing a transition to new market data services is disclosed. The system and method include a market data services provider and a client. The provider presents the client with a standard scorecard which is used to report the progress and status of various aspects of the transition project using metrics. The client is able to customize the scorecard by suggesting additional parameters and editing its content to tailor the periodic reports to their needs. The provider then takes the proposed changes and undertakes an internal certification process to ensure that the metrics used are accurate, reliable, and consistent. The provider then proceeds with the transition process, providing an updated scorecard to the client at periodic intervals to allow the client to monitor the progress of the transition and relieve any concern regarding delays and/or increased costs.

### FIELD OF THE INVENTION

The present invention relates to project management systems and methods, and more particularly to a system and method for providing a transition to new market data services.

### BACKGROUND

The measurement of sales in retail channels can be done using a variety of methods. Initially, sample-based audits of consumer purchases at retail check-outs were extensively utilized—but were costly and subject to significant potential inaccuracies. Due to recent improvements in scanner-based point of sale (POS) data, market tracking services such as those offered by Information Resources, Inc. (IRI) , and A.C. Nielsen (ACN) are able to provide highly-granular (in terms of item, venue, and time), highly-accurate measurement of sales in several retail channels—including food/grocery, drug, mass merchandise, convenience, and military commissary.

By performing analysis on syndicated POS data, market data services providers are able to derive a wealth of information for their clients, who are often manufacturers, service providers, and retailers. For example, manufacturers can improve their understanding of their market segment and their consumers, including the consumer's preferences, loyalties, habits and concerns. This allows the manufacturer to better understand how to provide unique and innovative products that satisfy their customer's needs. Additionally, retailers are able to answer valuable questions concerning whether shoppers can easily find the product they need, how a consumer decides between competing products, and who their most loyal customers are.

As the providers of market data services offer increasingly different functionality and evolve their information analysis techniques to individually provide more valuable information, clients are inclined to select a new market data service provider. Traditionally, the desire to transition from one market data service provider to another or to adopt market data services initially has been inhibited by the large transaction costs and time required to effectively effectuate the change. Transitions can be currently burdened with large demands for client time, unpredictable budgets, and inaccurate time frames for completion. Therefore, by necessity, many customers were forced to either do without these valuable services or remain with their current less favorable provider.

Accordingly, there is a need for improvements in the area of market data service transitions. Further advances are needed in this area in order to provide a relatively pain free, predictable, and reliable transition method.

### SUMMARY

One form of the present invention is a unique method for providing a transition to new market data services. These are precisely summarized in the claims, and the following is merely illustrative and optional.

Another form includes the market data services provider sending the client a plurality of metrics designed to track the progress of an associated task in a transition to new market data services. The client may then provide feedback to the provider including a plurality of proposed parameters characterizing said transition to new market data services. The provider then may associate a metric with at least one proposed parameter in said plurality of proposed parameters. The provider may then able to periodically represent the progress of the transition project on a status scorecard using the metrics and provide the current updated status scorecard to the client.

Yet another form includes the market data services provider receiving feedback including a plurality of proposed metrics. The provider then may attempt to locate an existing metric in an internal database of existing metrics which meets the goals of the proposed metric. If a match is found, the provider may associate the identified metric with the proposed parameter. The provider may then be further able to periodically represent the progress of the transition project on a status scorecard using the identified metric.

A still further form includes the market data services provider receiving feedback including a plurality of proposed metrics. The provider may then attempt to locate an existing metric in an internal database of existing metrics which meets the goals of the proposed metric. Upon failing to find a suitable metric, the provider may complete a metric definition which would satisfy the needs of the proposed parameter. The metric definition may then be presented to a certification authority to ensure universal compliance. Once approved, the provider may include the new metric on the scorecard as a representation of the proposed parameter. The provider may then be further able to periodically represent the progress of the transition project and the proposed parameter on a status scorecard using the identified metric.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagram showing a sample system architecture in which the present system and method may function.

FIG. 2 is a diagram showing the interaction between a market data services provider and a client during a transition illustrating one approach to the present system and method.

FIG. 3 is a process flow diagram demonstrating one example of stages involved in providing a transition to new market data services in one embodiment of the present system and method.

FIG. 4 is a representative example of a generic scorecard in accordance with one embodiment of the present system and method.

FIG. 5 is a detailed process flow diagram illustrating one example of steps to obtain certification on a true metric.

FIG. 6 is a process flow diagram showing the process for completing one iteration of the periodic scorecard updating process.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One embodiment of the present invention includes a unique system and method for providing a transition to new data services. This process typically begins upon the completion of a contract or agreement between the market data services provider and the client. “Market data” services is intended to mean any services which provide information, research, analysis, or statistics derived from consumer products and services transaction data. By way of non-limiting example, market data services providers include Information Resources, Inc. and A.C. Nielsen Inc., to name just a few representative examples. Furthermore, a metric, is intended to mean a measurable element of a service process or function. For example, if there is a contract requirement to train at least 100 employees of the client, the metric is the number of employees trained thus far. The accuracy of the number of employees trained can be compared to a standard or prediction to determine the quality of the service.

For many potential or existing market data services clients, the decision to include market data services in their company strategy or to change their provider is one that is influenced by many factors. In an ideal world, for instance, a potential client may choose to adopt market data services due to a recent growth in the number of competitors in the market or a desire to increase their current market share. However, unfortunately, potential clients must also factor in the transaction costs associated with adopting new market data services. To go a step further, prior methods employed by data service providers have often proven unreliable, inaccurate and consistently behind schedule. These challenges frustrate potential clients and make it difficult for them to properly assess the initial costs associated with transitioning to new market data services. Thus, absent a willingness to adopt this risk, potential clients are often discouraged from adopting new and better market data services, or forced to remain with their current inferior provider to avoid these obstacles.

If a market data services provider were able to accurately predict the cost and time frame for completing a market data services transition, then a potential client would be able to rely on the provider's estimates in making a sound business decision. In addition, if the market data services provider were able to provide a periodic snapshot of their progress in the transition to the client, then the client would be at ease with the project as it progresses and in control and able to participate when issues arise. Ultimately, by breaking down the risks and uncertainties involved in transitioning to market data services, a provider is able to better inform potential clients about adopting their services and increase client satisfaction and commitment throughout the process.

Irrespective of the method used, a market data services transition is a large, complex, and time consuming process which requires the commitment by both parties of substantial monetary and human resources. In order to efficiently handle this transition, and assign responsibility, the market data services provider in the illustrative embodiment is represented by a “transition team” comprising a hierarchy of employees each assigned to complete and monitor different aspects of the transition process. In the illustrative embodiment, this transition team is lead by a director, through whom all communication with the client is channeled and who serves as a liaison between the sub-groups of the transition team working on various aspects of the project. It shall be understood that any action described herein as being performed by the “market data services provider” or “provider” is actually performed by one or more members of the market data services provider's transition team.

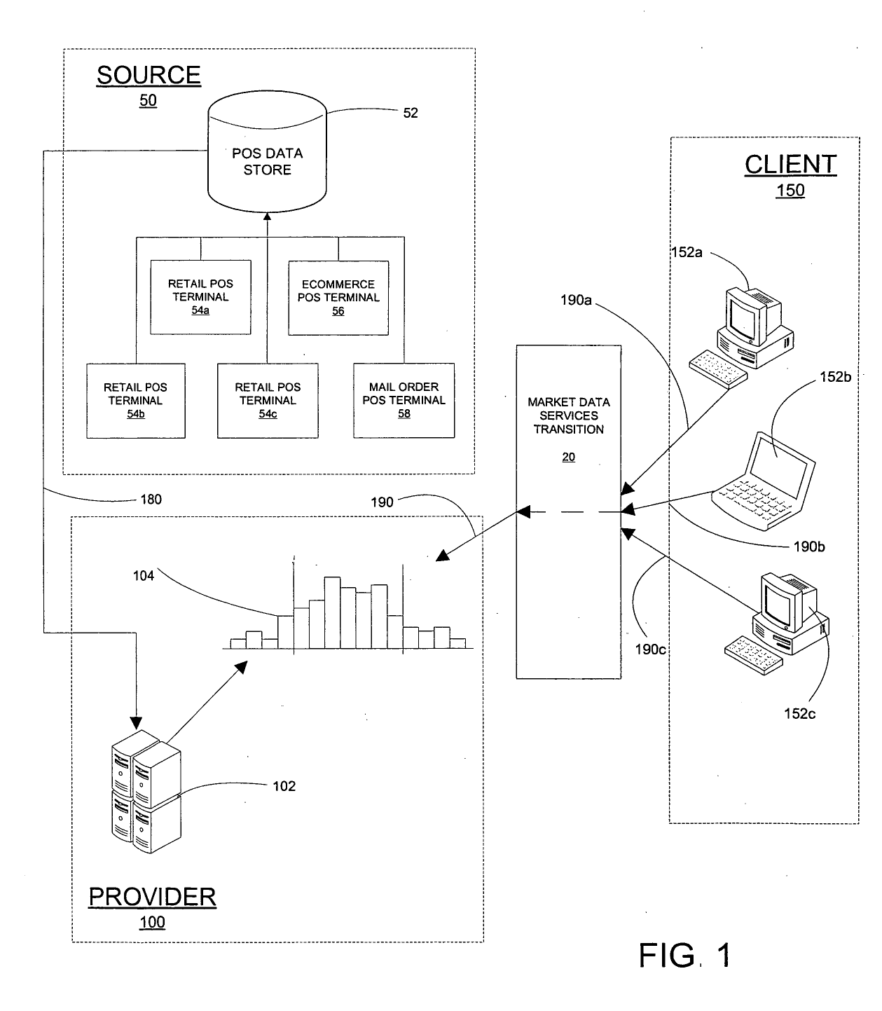

FIG. 1 is a diagram showing a sample system architecture in which the present system and method may function. The system includes resources which may be located in one location or remotely with a plurality of different parties. The illustrated architecture shows three parties including a market data source 50, a market data services provider 100, and a client 150. The market data source 50 includes point-of-sale (POS) data store 52, individual retail store POS terminals 54a, 54b, and 54c, e-commerce POS terminal 56, and mail order POS terminal 58. Typically, market data source 50 stores information from barcodes that is automatically gathered as a consumer's purchases are put through a check-out at a POS terminal such as retail POS terminal 54. Ordinarily, the information gathered would identify which customer bought what products, at what prices, and when and where the transaction took place. These POS terminals collect enormous volumes of such data every day which is stored in POS data store 52. According to a report in Darwin Magazine, the Staples office supply chain collects a gigabyte of data daily from its United States stores alone.

Market data services provider 100 includes computer processing system 102. Computer processing system 102 is often a large computer system implementing complex data analysis algorithms for extracting useful information from market data obtained from market data source 50 through connection 180. Typically, market data services provider 100 creates a data visualization package 104 and provides access to the client 150 through a connection 190 such as 190a, 190b, or 190c.

Client 150 is typically a consumer products or services manufacturer, wholesaler, retailer, or distributor. Client 150 typically includes client user terminals 152a, 152b, and 152c. It shall be understood that fewer or more user terminals 152 may be utilized, but only three have been shown to preserve clarity. Client user terminals 152 are commonly desktop or laptop computers, and may contain software provided by provider 100. For example, a client 150 might apply predictive technology software obtained from the market data services provider 100 to a set of data obtained from market data source 50 to help them plan when or where to launch a sales campaign, or how to price an item. Additionally, the client user terminals may access visualization package 104. It shall be understood that visualization package 104 is illustrated as a graph for simplicity, but could include many other forms including reports, 3-D images, spreadsheets, charts, and other forms of presenting and communication information.

The system and method for transitioning to new market data services 20, described herein, operates between the market data source 50, provider 100, and client 102. The method 20 may perform a plurality of steps to allow client 150 to obtain access to information extracted and/or customized from data obtained from market data source 50 by provider 100.

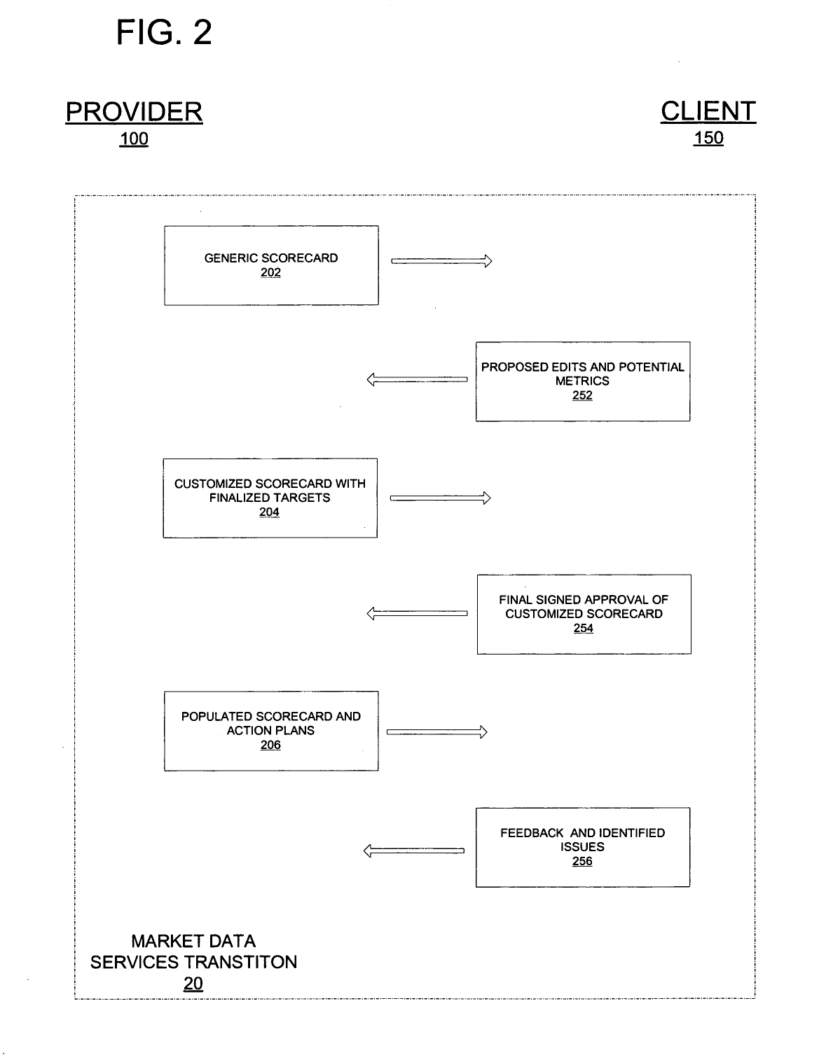

FIG. 2 is a high level diagram showing the interaction between a market data services provider and a client during a transition illustrating the present system and method. FIG. 2 shows the two principal parties to the transition process 20, the market data services provider 100 on the left and the client 150 on the right. Each entry below the two parties indicates an item being communicated from one party to another. The item can be communicated through several methods depending upon the item including, by way of non-limiting example, email, standard mail, fax, secure webpage, and/or voice communication.

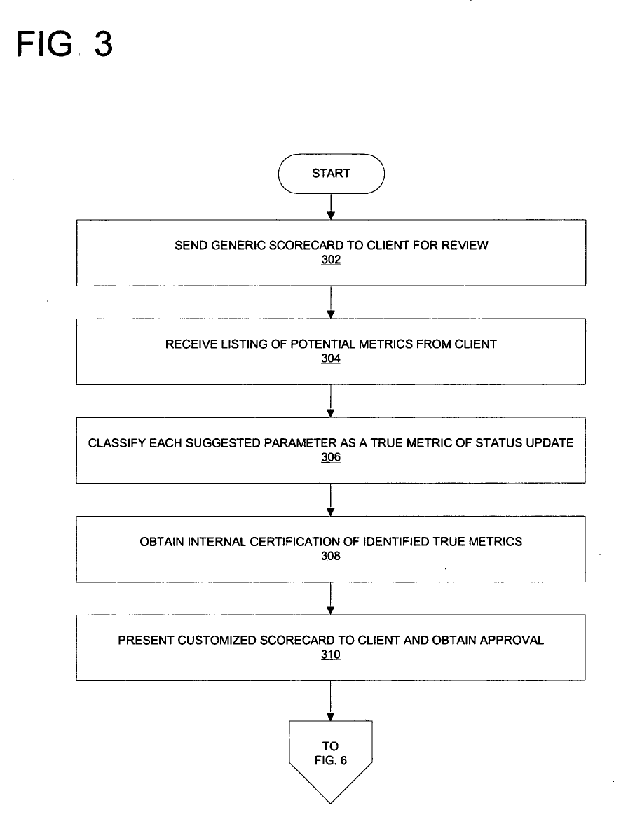

FIG. 3 is a high level process flow diagram demonstrating the stages involved in providing a transition to new data services in one embodiment. It shall be understood that some steps may be excluded while additional steps may be included without departing from the spirit of the invention.

Referring now to FIGS. 2-3, the process for providing a transition to new market data services begins at stage 302 with the market data services provider 100 sending a generic scorecard 202 to the client 150 for review.

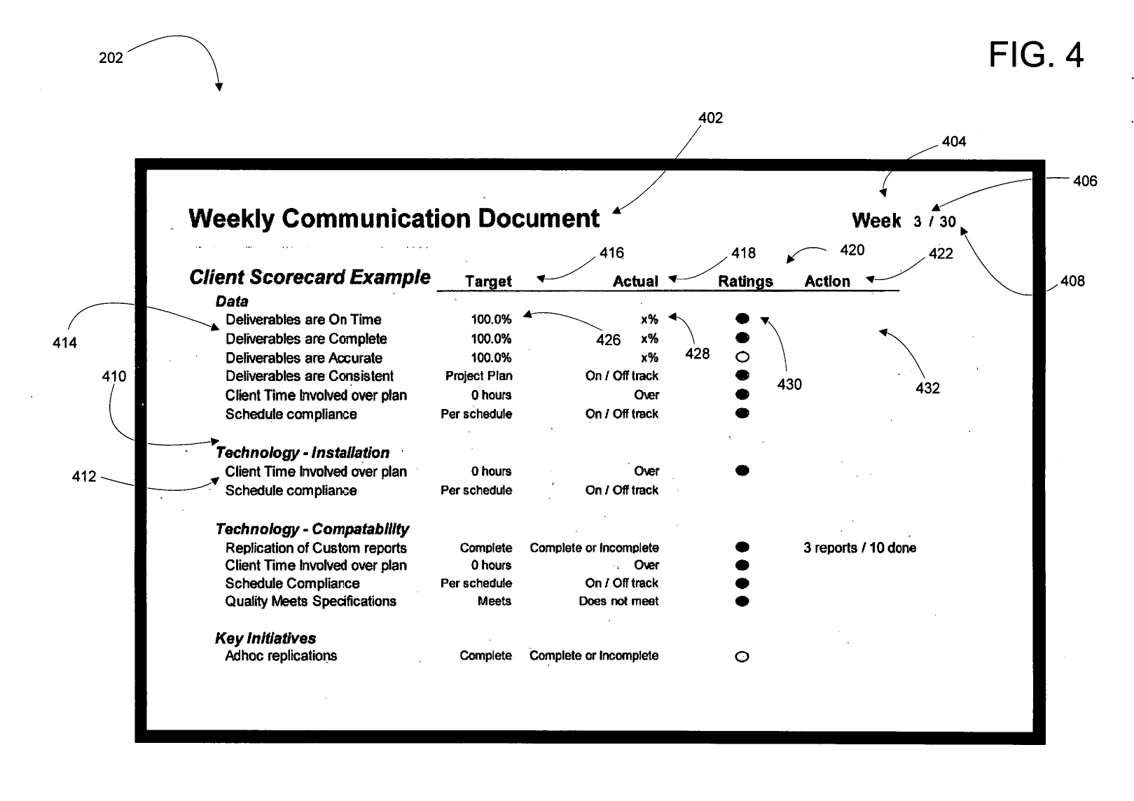

FIG. 3 illustrates a representative example of a generic scorecard 202 in accordance with one embodiment of the present invention. The generic scorecard in FIG. 4 contains project specific information such as a title 402 and timeframe 404. Title 402 is preferably tailored to include the client's name, while timeframe 404 indicates the current week of the project 406 and the estimated number of weeks the project will take to complete 408. It shall be understood that timeframe 404 could be arranged so as to indicate the current hour, day, fortnight, month, or year of the project measured against the estimated completion time depending upon the reporting frequency desired by the client.

The generic scorecard in FIG. 4 also includes a chart listing the metrics which track the status of the market data services transition. Listed in the left hand column are main categories, for example 410, which describe the major areas in which work is to be completed. In the illustrative example, the main categories may include “Data” for tracking the progress of integrating the client's products into the market data services provider's systems; “Technology-Installation” for tracking the progress of installing the hardware and software needed by the client to utilize the services; “Technology-Compatibility” to track the progress of ensuring compliance and proper functionality after completion of the transition; and “Key Initiatives” to track important tasks identified by both parties; just to name a few representative examples.

Contained within each category are typically one or more metrics, such as 412 and 414, which are designed to accurately reflect the progress of their associated task. Additionally, the generic scorecard contains a separate column for each field associated with a metric, such as Target 416, Actual 418, Ratings 420, and Action 422. These fields are updated prior to providing a new iteration of the scorecard to the client during the actual transition process. For example, metric 414 indicates whether the “Deliverables are On Time.” The Target field 426 associated with metric 414 indicates the goal or objective of the data services provider during the transition process. Thus, as indicated by “100%” in the current example, it is a goal of the provider to meet every deliverable of the client on time. The Actual field 428 associated with metric 412 shows the current status of this metric represented by “x %”. For instance, if 20 deliverables had been met to this point, only one of which was behind schedule, then field 428 would have a value of 95%.

The generic scorecard also includes a Ratings column 420 containing color-coded fields, such as field 430, for easily allowing the client to get a feel for the progress of each metric. For example, a red bubble would indicate that a metric is unsatisfied or has fallen behind plan, a yellow bubble would indicate that issues exists with the associated metric, and green bubble would indicate that the metric is progressing either ahead of or according to plan. Additionally, the generic scorecard includes an Action column 422 contain Action fields, such as 432, for holding information concerning the actions taken or upcoming relative to the corresponding metric. For example, the Action field 432 may indicate the total number of reports completed, the total number of employees hired and/or trained, or the field may identify an upcoming issue that warrants special client attention.

Returning to FIGS. 2-3, once the provider has sent the generic scorecard 202 to the client for review (stage 302), the market data services provider 100 receives feedback and a listing of potential metrics 252 from the client 150. By providing the client 150 with the generic scorecard 202, the provider 100 is able to show the client 150 which metrics it has recognized as good indicators of a transition project's status. Additionally, the client is able to edit the generic scorecard 202 and propose metrics which would track deliverables which are critical from their perspective. In a further preferred embodiment, the client is able to utilize these critical deliverables as a basis for contractual terms. For example, a client may contract with a provider for market data services for a number of years. However, the contract may contain provisions such that the rate may increase/decrease based upon the percentage of deliverables met on time, or that the term may extend automatically depending upon the quality of service given during the transition. This method provides encouragement for both sides in that the provider is rewarded with a longer contract for a high quality transition process, while the client is able to reduce the length and cost of the contract in the event of a less than favorable transition.

Once the market data services provider receives feedback and any metrics proposed by the client (stage 304), the provider undertakes an internal procedure to classify each potential metric as a true metric or as merely a status update (stage 306). For example, a true metric is a measured value, such as the number of employees trained, the percentage of deliverables met on time, or the amount of client time utilized, to name a few representative examples.

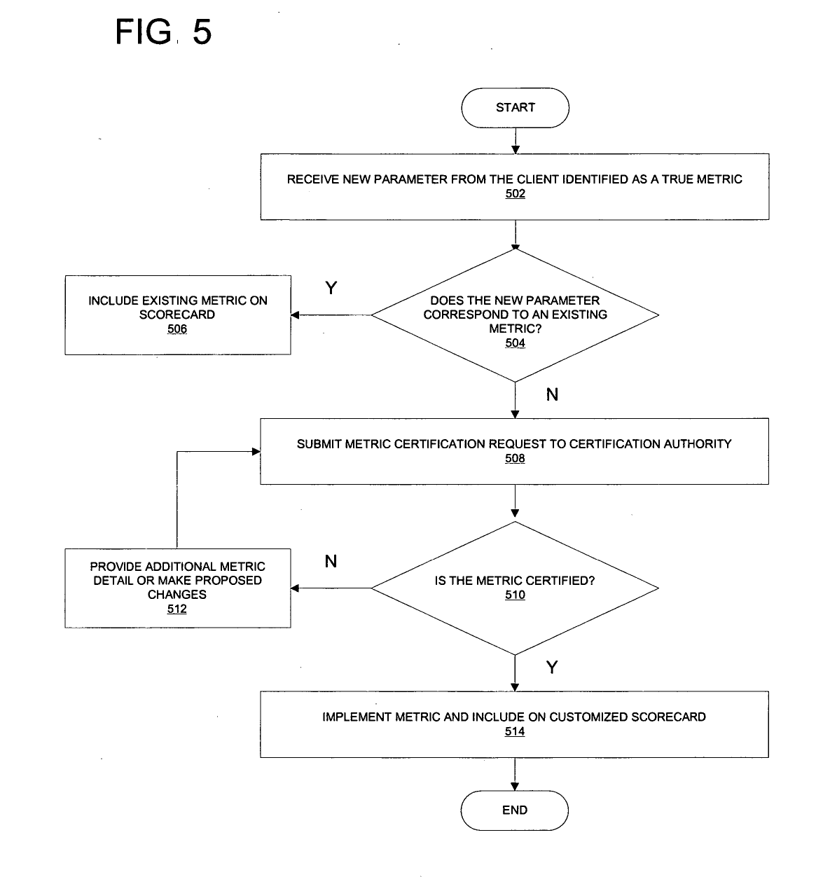

Having identified the true metrics (stage 306) from the potential metrics proposed 252 by the client, the provider proceeds to obtain certification of the additional true metrics (stage 308). FIG. 5 is a detailed process flow diagram illustrating the steps to obtain certification of a true metric. The metric certification process begins by receiving a potential metric which has been identified as a true metric (stage 502). The provider then searches in a repository of pre-existing certified metrics for a metric which would suit the needs identified by the client (stage 504). All of the metrics in the repository follow a standardized format to allow easy portability between clients. Therefore, if a suitable metric is identified, it can be easily included on the customized scorecard for the current client (stage 506). If, however, no prior metric is appropriate, then the provider would ordinarily proceed to obtain internal certification of a new metric suiting the client's need.

To certify a metric the provider formulates a clear and unambiguous understanding of the purpose and application of the metric. In the preferred embodiment, internal meetings to determine the best metric to meet the need specified by the client are conducted. In a further preferred embodiment these meetings are usually iterative and occur over an extended period of time in order to allow sufficient brainstorming time, creativity, and consideration of both advantages and costs.

Once this is complete, a metric certification request may be prepared. In one embodiment, the metric certification request is in the form a standard template which encompasses all the information that is needed to define a metric for certification and consideration. In a further embodiment, this form is downloadable from an internal web-site or data store. Once complete, this metric certification request is submitted to a metric certification authority for approval (stage 508). In a preferred embodiment, the request is submitted through a web page and scheduled for hearing at the next meeting of the certification authority. In the illustrative embodiment, the certification authority is an internal team of three experienced employees who have high-level knowledge of the internal systems and goals of the provider. The certification authority will review the request for completeness, accuracy, and compliance with internal standards to ensure the quality of the metric before allowing it to be implemented, and eventually relied upon the by the provider's employees and eventually the client.

A decision point 510, if the metric certification authority denies approval to the metric definition, then the certification application is returned to the appropriate party for modification and entry of proposed additions (stage 512). The application for certification can be resubmitted for review at the next meeting of the certification authority by returning to stage 508.

If the certification authority gives its approval, the metric is certified and the provider can implement the metric (stage 514) by making any necessary modifications or additions to the internal software to facilitate tracking of the new metric. Additionally, the metric can be included upon the customized scorecard of the client from this point forward.

Returning to FIGS. 2-3, once the true metrics identified in stage 306 have been certified and implemented (stage 308), a customized scorecard 204 is presented to the client 150 in stage 310. In the illustrative embodiment, this customized scorecard 204 contains the metrics suggested by the provider 100 along with any edits suggested by the client 150 as well as the newly certified metrics proposed by the client. In addition, the scorecard can be tailored to include the client's name, logo, color scheme, and other items to produce an aesthetically pleasing appearance.

Once the client 150 has received the customized scorecard 204, the client is able to review the changes made to the generic scorecard 202 as well as the final targets put forth by the provider 100. In the illustrative embodiment, the final targets will reflect the timeframe for completion of several tasks. Additionally, the final scorecard will reflect the estimated duration of the project. If the client is satisfied with the content of the customized scorecard 204, the client 150 communicates final signed approval 254 to the provider 100.

Now that the provider has received final approval from the client of the customized scorecard, the transition process shifts from preparation and planning to actual implementation. Once the transition implementation has begun, the customized scorecard is populated with baseline metrics, which will be periodically replaced with the current updated metrics throughout the transition project.

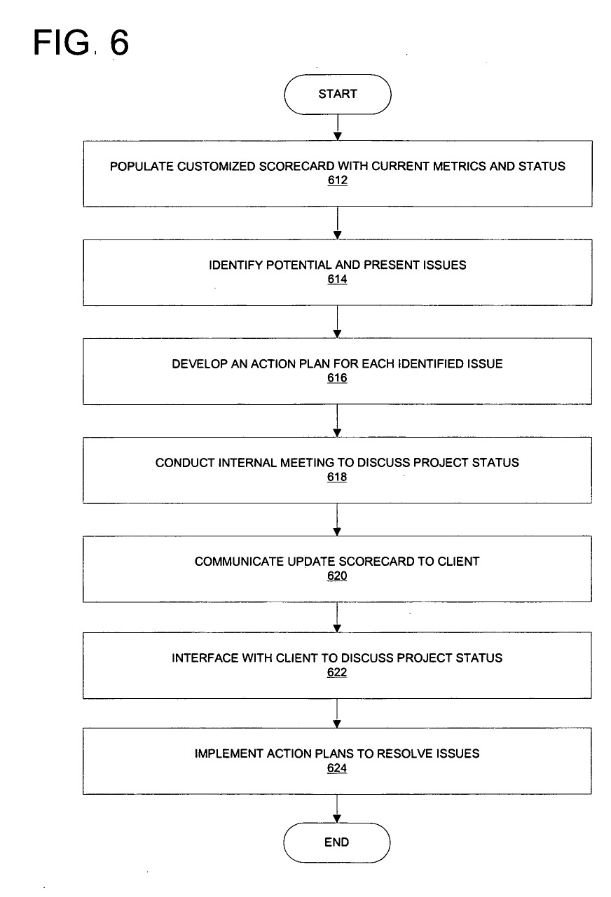

FIG. 6 is a high level process flow diagram showing the process for completing one iteration of the periodic scorecard updating process. In one embodiment, the time frame for completing each iteration is one week. The process beings at stage 612 with the provider populating the customized scorecard with the current metrics and other accompanying information. In addition, the provider identifies any metrics which are behind schedule or have outstanding issues (stage 614). For example, a lack of attendance at recent training classes for the client's employees may prompt a metric indicating the number of employees trained thus far to fall behind schedule. Thus, the issue of improving client employee attendance would be created.

Once the populated scorecard is updated, action plans are generated as needed (stage 616) for identified issues. In order to create an action plan, the provider examines the current progress of the associated metric. The provider attempts to ascertain the nature of the issue and identify its source. Once this has taken place, the provider creates the action plan, describing the issue, its source, and the steps necessary to bring the task back up to speed. Examples of remedies may include the re-allocation of resources, a change in prioritization of tasks, or simply employing a better/more efficient practice.

With the current status of the transition updated on the customized scorecard, the provider then coordinates an internal meeting (stage 618) to discuss the project status as well as the accuracy of the information provided to the client. For instance, if the provider feels that the several issues may hold up the project down the line unless they are promptly addressed, that issue may be raised and discussed with others responsible for other tasks on the project. Therefore, when the customized scorecard is presented to the client for review, the metrics and accompanying information on the scorecard are as accurate as possible and can be relied upon. During this meeting, upcoming deadlines and major steps of the transition are detailed so that all members of the transition team are aware.

Once the customized scorecard and action plans 206 are completed and discussed, they are communicated to the client for review (stage 620). In the illustrative embodiment, the scorecard and action plans are sent to the client via e-mail and a subsequent meeting is scheduled to discuss the current status of the transition.

At the previously scheduled time, the provider meets with the client, preferably via telephone, videoconference, or in person, to discuss the current project status and address any concerns raised by the updated scorecard. The client is able to provide feedback 256 concerning the project status and any identified issues to the provider in order to meet their needs.

Once the client has had an opportunity to comment on the current status of the project, the provider is able to make adjustments as necessary and implement the action plans to bring any deficient area of the project into compliance with the forecasted metrics.

This process of updating the scorecard, discussing project status internally, communicating with the client, and implementing the developed action plans occurs periodically throughout the duration of the transition process. For example, a transition may be forecasted to require 60 weeks, and the client may desire to have an updated scorecard submitted to them weekly.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method comprising:
providing a plurality of metrics designed to track the progress of an associated task in a transition to new market data services to a client;
receiving feedback from said client including a plurality of proposed parameters characterizing said transition to new market data services;
associating a metric with at least one proposed parameter in said plurality of proposed parameters;
representing the progress of said transition on a status scorecard using said metric and said plurality of metrics; and
providing said status scorecard to said client on a periodic basis.

2. The method of claim 1 wherein said transition to new market data services is a transition from one market data services provider to a new market data services provider.

3. The method of claim 1 further comprising the step of:
receiving market data including data about at least one of said client's products.

4. The method of claim 3 further comprising the step of:
performing an analysis on said market data.

5. The method of claim 4 further comprising the step of:
communicating said analysis to said client.

6. The method of claim 1 wherein said metrics are stored on a computer system.

7. The method of claim 6 wherein said metrics are updated on said computer system without manual intervention.

8. The method of claim 1 wherein said feedback includes a timeframe for completion of the transition project.

9. The method of claim 1 wherein said plurality of metrics includes a metric measuring the amount of client time utilized.

10. The method of claim 1 wherein said plurality of metrics includes a metric measuring the number of training classes completed.

11. The method of claim 1 wherein said plurality of metrics includes a metric measuring the number of new employees hired.

12. The method of claim 1 wherein said plurality of metrics includes a metric measuring the number of required employees who have been trained.

13. The method of claim 1 wherein said status scorecard is sent to said client via e-mail.

14. The method of claim 1 wherein said status scorecard is made available to said client on a secure webpage.

15. The method of claim 1 wherein said status scorecard is sent to said client via facsimile.

16. The method of claim 1 wherein said periodic basis is weekly.

17. The method of claim 1 wherein said periodic basis is monthly.

18. The method of claim 1 wherein said periodic basis is defined by said client.

19. The method of claim 1 further comprising the steps of:
identifying at least one metric in said plurality of metrics indicating that said associated task is behind schedule; and
in response to said identifying, developing an action plan to bring the progress of said associated task up to pace.

20. The method of claim 19 wherein said action plan includes a re-allocation of resources.

21. The method of claim 19 wherein said action plan includes a re-prioritization of tasks.

22. The method of claim 19 further comprising the step of communicating said action plan to said client.

23. The method of claim 20 wherein said resources are employees.

24. The method of claim 1 wherein said associating further includes the steps of:
identifying the type of metric needed to accurately represent the proposed parameter; and
locating said metric in a collection of prior metrics.

25. The method of claim 1 wherein said associating further includes the steps of:
identifying the type of metric needed to accurately represent the proposed parameter; and
establishing a definition for said metric;
submitting said definition to a certification authority for approval; and
implementing said metric.

26. The method of claim 25 wherein said certification authority is an internal panel comprising a plurality employees of said market data services provider.

27. The method of claim 25 wherein said definition is a completed pre-established template.

28. The method of claim 25 wherein said definition is submitted to said certification authority online.

29. The method of claim 1 wherein said metric has an associated process owner responsible for the generation of said metric.

30. The method of claim 29 further comprising the step of:
obtaining approval of said metric from said associated process owner prior to providing said status scorecard to said client.

31. The method of claim 1 wherein said scorecard is a web page.

32. The method of claim 1 wherein said scorecard includes a color coded field indicating the status of at least one of said metrics.

33. The method of claim 32 wherein a green color indicates that said metric is on track.

34. The method of claim 32 wherein a yellow color indicates that said metric has associated issues.

35. The method of claim 32 wherein a red color indicates that said metric is behind schedule.

36. The method of claim 32 wherein said color coded field is generate programmatically using said metrics.

37. The method of claim 36 wherein said metrics are stored on a computer system.

38. A computer readable medium capable of carrying out the steps recited in claim 1.
